(19) United States
(12) Patent Application Publication
(10) Pub. No.: US 2020/0371955 A1
(43) Pub. Date: Nov. 26, 2020

(54) MEMORY CONTROL FOR ELECTRONIC DATA PROCESSING SYSTEM

(71) Applicant: BAMBOO SYSTEMS GROUP LIMITED, Cambridge, Cambridgeshire (GB)

(72) Inventors: John GOODACRE, Cambridge (GB); Giampietro TECCHIOLLI, Cambridge (GB)

(73) Assignee: Bamboo Systems Group Limited, Cambridge, Cambridgeshire (GB)

(21) Appl. No.: 16/634,064

(22) PCT Filed: Aug. 3, 2018
(86) PCT No.: PCT/GB2018/052229

§ 371 Date: Jan. 24, 2020

(30) Foreign Application Priority Data
Aug. 4, 2017 (GB) 1712579.0

(51) Int. Cl. G06F 12/1072; G06F 12/02; G06F 12/0811; G06F 15/173

(52) U.S. Cl. CPC G06F 12/1072; G06F 12/0292; G06F 12/0811; G06F 15/17331; G06F 2212/657; G06F 2212/2542; G06F 2212/651; G06F 2212/656; G06F 2212/152

(57) ABSTRACT

Disclosed are machine-implemented methods and apparatus for memory access and control for an electronic data processing system, comprising allocating, statically or dynamically, ownership of a partition of a global remote memory address space in addition to local memory address space created by at least one local electronic data processing system; presenting local memory access requests for the global remote memory access through a to-remote bridge component identified within a partition of the local address space of the electronic data processing system for translation of the local address into a corresponding translated address in a partition of the global remote memory address space; and receiving a global remote memory access request within the allocated partition by the electronic data processing system through a from-remote bridge for translation of the global remote address into a corresponding translated local address for direct and consistent access to the corresponding local memory address.

The present technology relates to apparatus and methods for controlling and accessing memory in a system having plural electronic data processing devices connected to respective memories by data communications means.

In various implementations, a first approach in the present technology provides a machine-implemented method of operation of memory access and control for an electronic data processing system, comprising allocating, at least one of statically and dynamically, ownership of a partition of a global remote memory address space in addition to local memory address space created by at least one local electronic data processing system; presenting local memory access requests for the global remote memory access through a to-remote bridge component identified within a partition of the local address space of the electronic data processing system for translation of the local address into a corresponding translated address in a partition of the global remote memory address space; and receiving a global remote memory access request within the allocated partition by the electronic data processing system through a from-remote bridge for translation of the global remote address into a corresponding translated local address for direct and consistent access to the corresponding local memory address.

In a second approach, implementations of the present technology provide machine-implemented method of operation of memory access and control for an electronic data processing system, comprising allocating, at least one of statically and dynamically, ownership of a partition of a global remote memory address space in addition to the local memory address space created by at least one local electronic data processing system; presenting local memory access requests for the global remote memory access through a to-remote bridge component identified by an “is-remote” flag associated with the entire local address of the electronic data processing system for translation of the local address into a corresponding translated address in a partition of the global remote memory address space; and receiving a global remote memory access request within the allocated partition by the electronic data processing system through a from-remote bridge for translation of the global remote address into a corresponding translated local address for direct and consistent access to the corresponding local memory address.

The method may further comprise the machine-implemented method wherein the corresponding translated local address for direct access to corresponding local memory address is coherent and consistent with concurrent access from any processor accessing the local memory address. The method may further comprise at least one additional level of translation action within at least one of the to-remote bridge and the from-remote bridge when at least one of the local electronic data processing system and the remote electronic data processing system comprises a memory translation hierarchy in the associated processing units. The memory translation hierarchy of processing units may comprise at least one of a hypervisor-guest arrangement and an operating system-application arrangement, and wherein the guest and the application comprise at least one native memory arrangement subordinate to a hierarchically superior memory arrangement of the hypervisor and the operating system.

The method of operation may further comprise storing at least one address at a level of the memory translation hierarchy of processing units with an additional indicator to indicate that the address translation is remote; and making the additional indicator available on at least one memory transaction to cause routing of the memory transaction to the to-remote bridge component. The local memory access request may be presented with an associated processing unit translation hierarchical level and translation context identifier at the to-remote bridge. Passing the local memory access request may comprise using a translation context identifier associated with an instance of a translation at a level of the hierarchy of processing units within the bridge translation. Passing the local memory access request and the translated memory address may further comprise incorporating the translation context identifier and the level of hierarchy within the translated address. Responsive to receiving the from-remote translated address, the method may also parse to detect presence of at least one of a the translation context identifier identifying an operating context within the from-remote translated address and a hierarchical level identifier within the from-remote translated address; responsive to detecting a context identifier within the from-remote translated address, selecting a corresponding local address associated with the operating context; and responsive to detecting a hierarchical level identifier within the from-remote translated address, selecting a corresponding local address associated with the hierarchical level.

Selecting responsive to detecting the hierarchical level identifier may comprise further processing the hierarchical level identifier to derive a further hierarchical level identifier for use in the selecting a corresponding local address associated with a further hierarchical level. There may be provided a plurality of translation stages within the to-remote and from-remote bridge components, the plurality of translation stages being operable to provide different address mappings to render each of a plurality of the electronic data processing systems operable to share an input one of a set of the memory addresses while each corresponding memory address in the partition of the global remote memory address space is stored at a different physical location.

A switch fabric that interconnects a plurality of instances of the electronic data processing system sharing a global address space may be operable to be identified by a partition of an address space as a set of memory addresses to be presented at a from-remote bridge of at least one the electronic data processing system. Each device of a network of interconnected peer electronic data processing systems may be operable to share control of the global remote memory address space by configuring at least one of a mapping of a to-remote address to the global remote memory address space and a mapping of a global remote memory address to a local address.

In a third approach, implementations of the present technology may provide a machine-implemented method of associating an “is-remote” attribute with generation of a translated memory address, comprising providing a processing unit with a hierarchy comprising a plurality of levels of memory translation by which a memory address is translated into a resulting translated memory address; at any level of memory translation within the hierarchy tagging at least one address with an “is-remote” attribute; and subsequently maintaining a state of the “is-remote” attribute in association with the resulting translated memory address. The tagged address may comprise an is-remote indication and at least one additional attribute selected from a level of said translation hierarchy and a context identifier.

Implementations of the present technology are thus operable to permit extensive expansion of addressable memory space through a hierarchy of addressing mechanisms spread over an interconnect or network of peer processing devices.

Implementations of the disclosed technology will now be described, by way of example only, with reference to the accompanying drawings, in which:

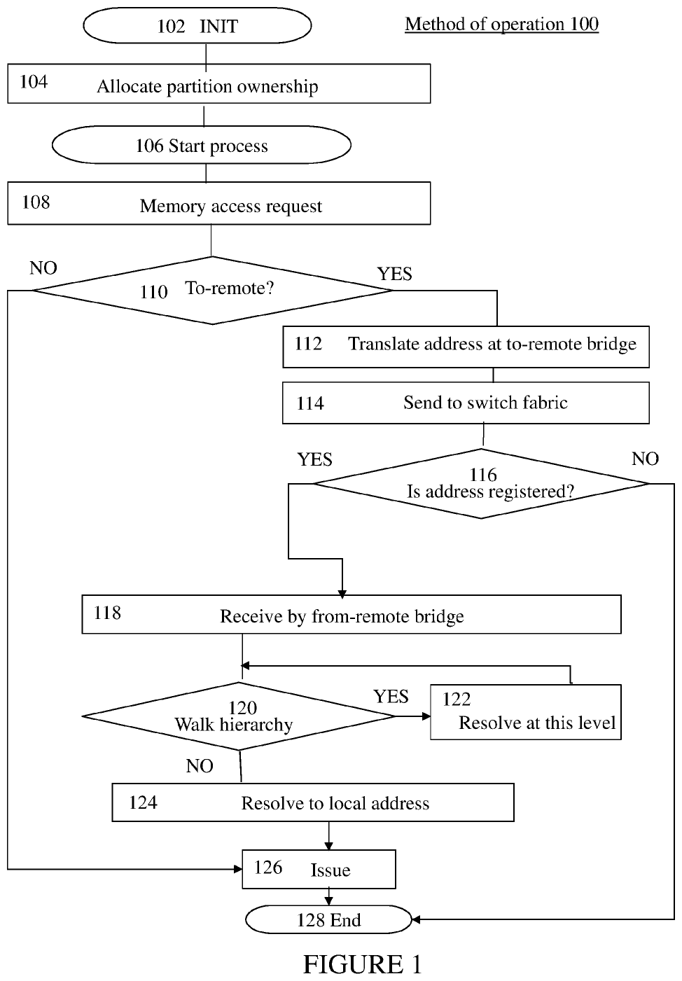

FIG. 1 shows one example of a method of operation for memory control and access according to the presently described technology; and

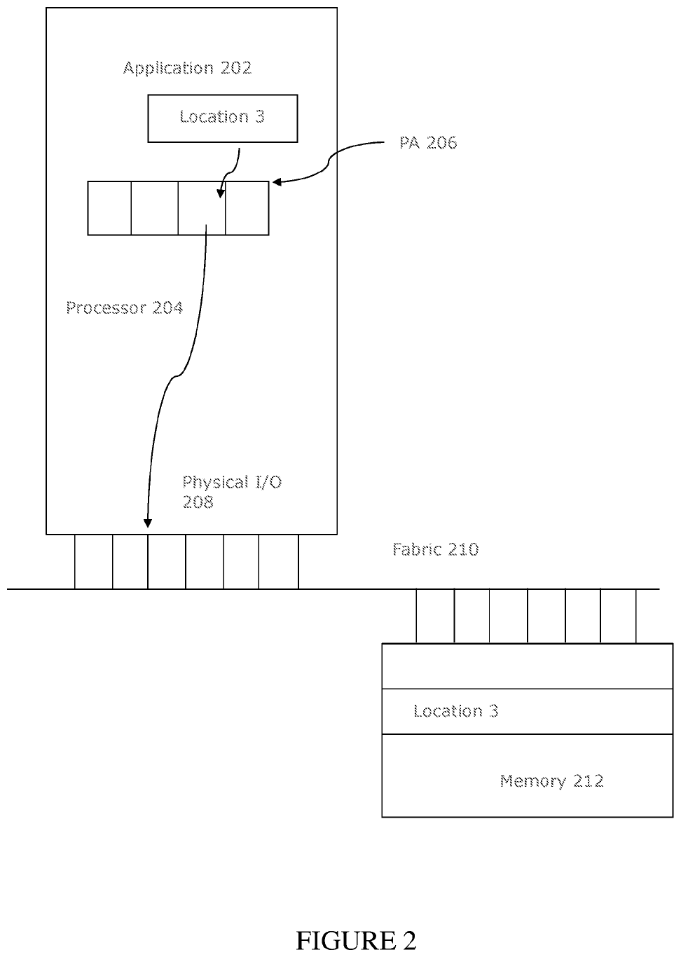

FIGS. 2 to 7 show various stages of development of processor and memory arrangements, to explain the features of each stage of refinement in the various approaches to memory control according to the present technology.

FIG. 1 thus shows an exemplary method of operation 100 of a processing unit, beginning at initialization step INIT 102, and at step 104, ownership of a partition of a global memory space is allocated. Normally, in a peer-to-peer arrangement according to one embodiment of the present technology, a from-remote bridge, processor or processor complex registers ownership, which ownership is then acknowledged by the switch fabric interconnecting the peer-to-peer arrangement. At some point subsequent to the initialization, the main process begins at step 106.

When a memory access request is generated at step 108, the identifier (address) of location to be accessed is tested at step 110 for “to-remote”, indicating that the requested memory location is not local to the requesting processor or processor complex either as part of the local address or from an is-remote flag. If the outcome of test step 110 is negative, the memory access request is handled locally by Issue step 126, and the process ends at End step 128. If the outcome of the test at test step 110 is positive, having found the address is set to indicate that the requested memory location is not local to the requesting processor or processor complex, the process continues to step 112, at which the address is translated by a to-remote bridge component. The request is then sent to the switch fabric at step 114. At test step 116, it is determined whether the address is registered with the fabric. If the outcome of test step 116 is negative, indicating that no such address is registered, the process ends at End step 128. If the outcome of test step 116 is positive, indicating that the address is registered, the request is received by the relevant from-remote bridge. If the system is configured with a hierarchy of levels, the hierarchy is scanned (“walked”) at step 120 to locate the correct level in the hierarchy, and if a level other than the current level is indicated, the address is resolved at that level in step 122. If no level other than the current level is indicated, the address is resolved into a local address at step 124, the request is issued at step 126, and the process completes at End step 128. Following End step 128, as will be clear to one of ordinary skill in the art, the process may be iterative, returning either to INIT step 102 to reinitialize the allocations of partition ownership, or to step 106 to continue processing with the current allocations of partition ownership.

Turning now to FIG. 2, there is shown a simplified arrangement of components of a data processing environment, for example, an embedded processor, with its associated components.

A simple data processing environment, for example, as used in embedded systems, includes a processor having a realtime operating system (RTOS), the processor sharing a communication means, such as a bus, with a memory. The memory locations are identified through physical addresses (PA).

Thus, in FIG. 2, Application 202 runs on Processor 204, which is connected through Fabric 210 to Memory 212. A memory location, for example, physical Location 3 as shown, has a physical address PA 206, and this physical address is used directly in memory requests through Physical I/O 208 means to access physical Location 3 in physical Memory 212.

In the following descriptions, a processor may be a single Central Processing Unit (CPU), a multi core processor containing multiple CPUs, known as a symmetric multiprocessor (SMP), or a plurality of connected SMPs, known as a

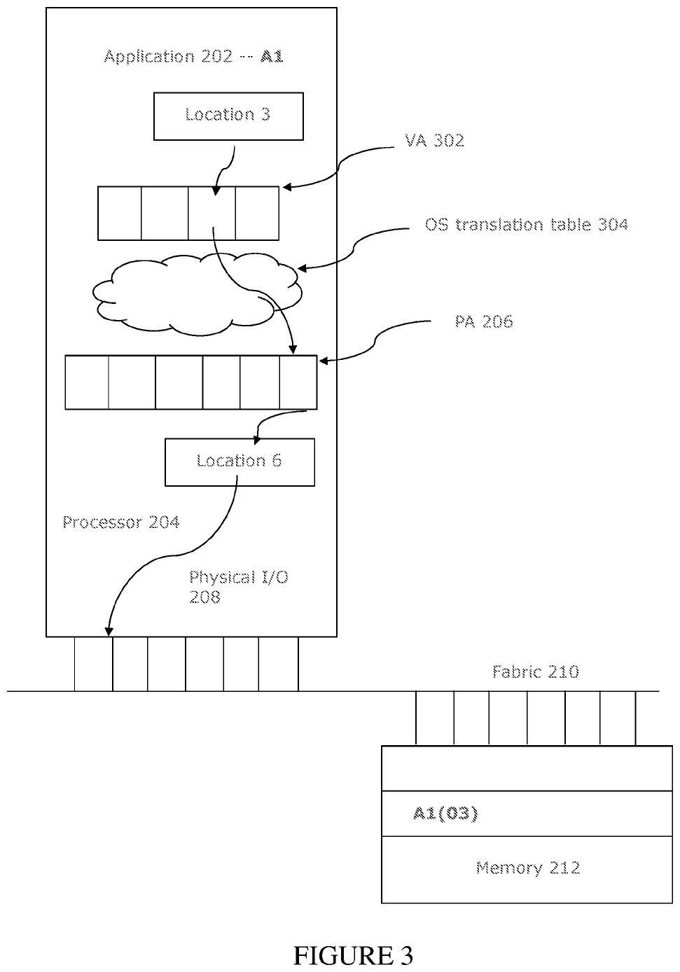

Non-Uniform Memory Access (NUMA) processor. In the multiple CPU cases, each CPU within the processor shares a common view of physical memory and can run multiple applications 202 in an independent virtual address space, such as VA 302 of FIG. 3, with the management of an operating system OS.

The OS running on the processor can run and manage one or more applications, and the processor is connected by an electronic communication means (which may be an on-chip connect, a bus, a local channel, or some form of remote communications link) to a memory.

The system shown in FIG. 2 is unsophisticated in comparison with present day systems; a simplified representation of a typical system is shown in FIG. 3.

In FIG. 3, each application 202, here exemplified as application A1, sees its own Virtual Address space (VA) 302 which is translated into a physical address of Physical Address table PA 206 by an Operating System managed translation table 304. In the example shown in FIG. 3, for Application 202 A1, Location 3 is an address in VA 302, and is mapped by Operating System (OS) translation table 304 on to location 6 of PA 206, and is thus enabled to access a location in physical memory that is shown in this example as (A1(03)). (A1(03)) is virtual Location 3 of application A1—in physical reality this is PA Location 6, but it is indexed as (A1(03)) for the purposes of application A1. This technology allows multiple applications to access one physical memory, such as Memory 212, through the management of one operating system running on Processor 204. The operating system is thus operable to map multiple application addresses from VA 302 to either a different or the same physical address in Memory 212. This allows applications to have a shared view of the mapped memory location.

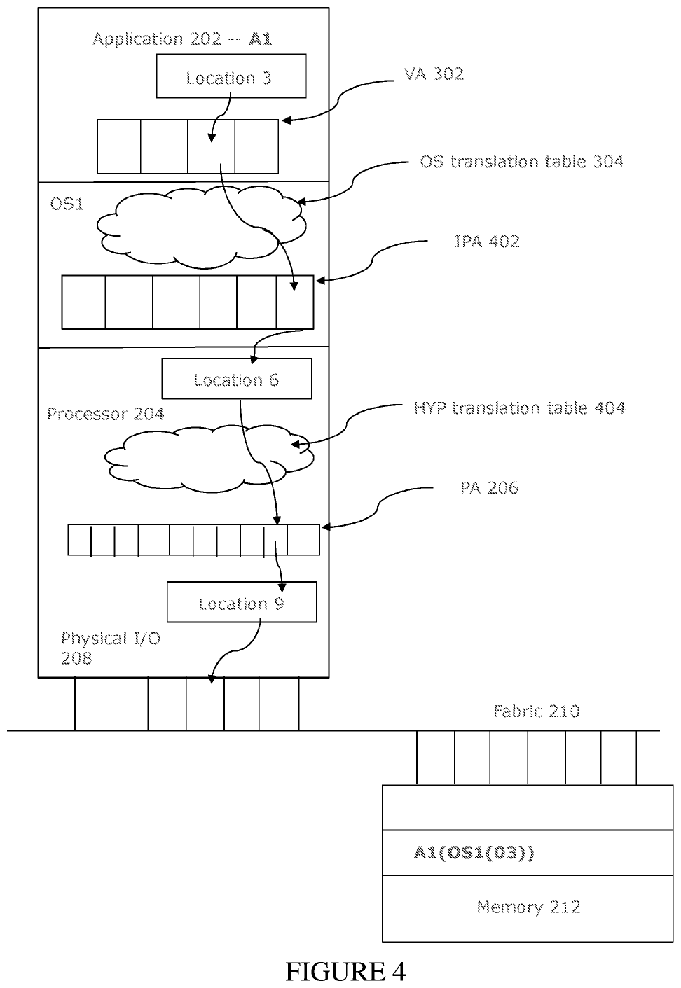

FIG. 4 shows a system supporting multiple virtualized operating systems, one of which is exemplified here as OS1, through the addition of a second memory address translation stage, which allows a hypervisor (HYP) to manage multiple operating systems, each one supporting multiple applications. As before, the operating system may share address translations to provide a shared view of the memory content between applications, but in addition the HYP may also share memory translations between operating systems on one processor. Thus, in FIG. 4, in addition to the components shown in FIG. 2 and FIG. 3, there is shown a portion of the Processor 204 under the control of operating system OS1. OS1 now has control of OS translation table 304 to map addresses from VA 302 to an intermediate physical address table IPA 402. 051 is operable, in the example, to map application A1's Location 3 to IPA 402 Location 6, which is in turn mapped by the hypervisor HYP through HYP translation table 404 to a location in PA 206, in the example, Location 9. Access to PA 206 Location 9 is made through Physical I/O 208 to Memory 212, where physical Location 9 is now indexed as A1(OS1(03)).

Attempts have been made to introduce refinements of the virtualized memory addressing systems shown in FIGS. 3 and 4, to provide access to a shared global address space although such attempts typically carry limitations in their scope—common examples are limitations in the scalability of the shared memory, difficulties with memory isolation, and the like.

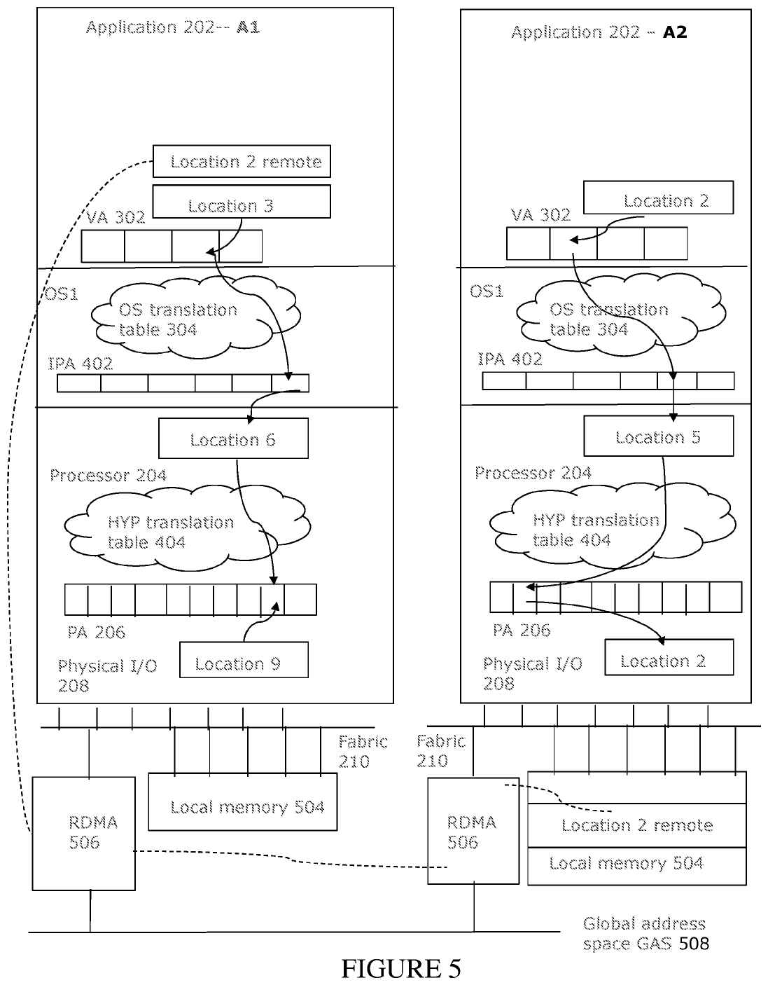

In one such attempt at improvement, as shown in FIG. 5, the PA 206 from a processor 204 is exposed as a partition of a global address space GAS 508. In FIG. 5, in addition to the features of FIGS. 1 to 3 is provided a Remote Direct

Memory Access component (RDMA) 506 which can bridge the Fabric 210 of multiple processors 204.

However, in such a system, the sum of the number of processing nodes times the size of the local memory 504 exposed into the GAS 508 per node must be less than the size of a single processor's PA addressable space. Also, Application 202 A1 and Application 202 A2 must manage through OS1 and HYP 204 the translation hierarchy 304, 404, to agree on what local memory 504 is shared at what location.

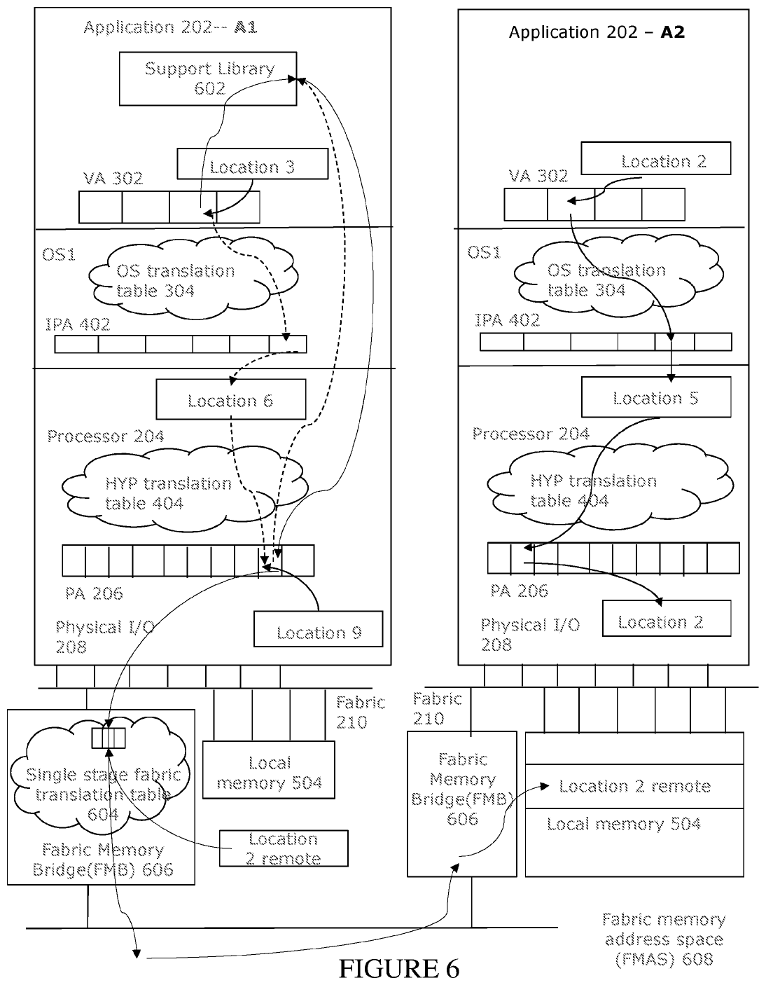

In a further attempt, FIG. 6, Fabric 210 replaces the RDMA 506 with a Fabric Memory Bridge (FMB) 606 to translate between the application's VA 302 and fabric memory address space (FMAS) 608. Either the OS or HYP translations are configured for the translated remoted location initially as invalid causing the address translation to be trapped by a software support library which first configures FMB 606 to access an associated FMAS 608 partition and then set the local translation for the associated remote memory request.

Although this solution extends the size of the FMAS beyond the size of the processor PA, the software management of the FMB and local translation limits performance with the FMB 606 implementing only a single stage translation between the application VA 302 and the FMAS 608, which limits a system to only a single FMAS 608 which is accessible in common across all the application VAs 302 and any virtualized OSs under the management of the support library. All applications within such a system share an FMAS 608 memory location, thus precluding the provision of multiple global shared spaces for different applications in different OSs.

In a yet further attempt, the GAS shares a partition of each processing unit local address space. The Fabric will forward the memory transaction for that address from any processing unit to a from-remote bridge owned by a specific processing unit. This bridge will have a single stage of translation that translates the presented GAS address into an address within the local address space. Although such a solution secures the local address space from incorrect remote requests, the GAS is limited in size to only a subset of the PA address space of the processing unit.

The present technology, by contrast, defines a system by which a given partition of memory address at one or more levels of the processor's memory translation hierarchy can be exposed to one or more globally shared views of the associated shared global memory space which can be larger than the processor PA without software intervention in the issue or receipt of memory operations. The memory address can then be translated into the corresponding remote processor translation hierarchy at a location defined by the remote processor.

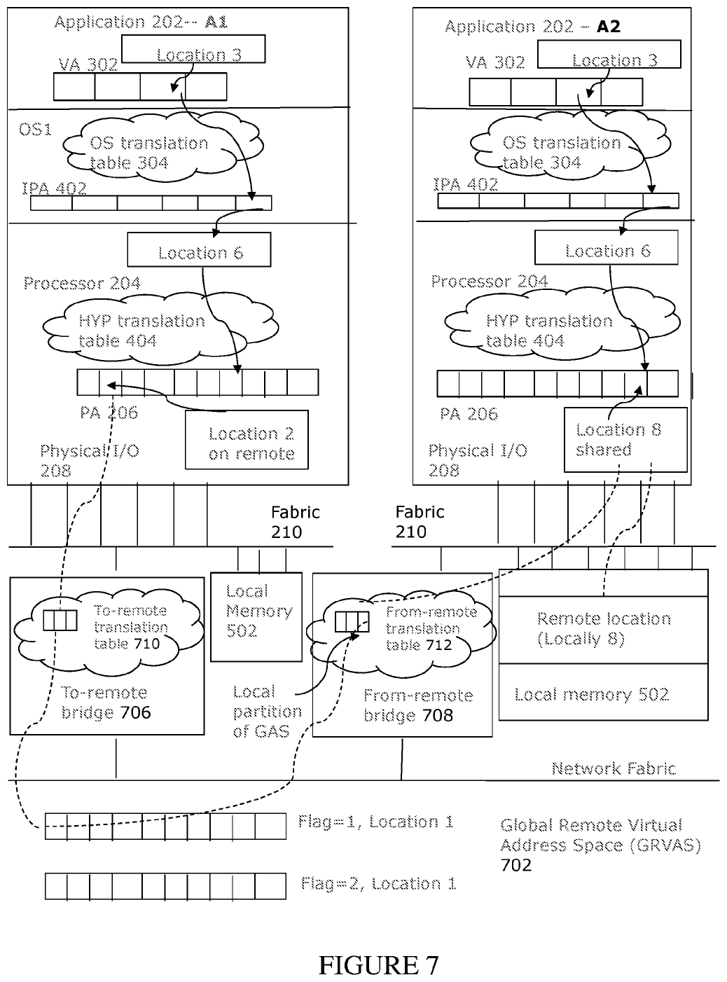

In FIG. 7 there is shown an arrangement by which a Global Remote Virtual Address Space (GRVAS) 702 can be controlled and accessed by additional enabling features according to the present technology. The processors 204 are connected to fabric components 704. Further provided are a to-remote bridge 706 and a from-remote bridge 708, by means of which flagged locations such as exemplary Location 2 on remote can be translated by the to-remote translation tables 710 to give the correct GRVAS location—in the example, Location 1 in GRVAS 702. Through the registration of Location 1 by the associated from-remote bridge 708, the GRVAS Location 1 is translated by the from-remote translation table 712 to access the local memory 502 shared location 8.

In its simplest form, where multiple virtual memory processors need to extend the virtual memory address translation of a specific application between multiple processors, the present technology introduces a single stage translation unit within the to-remote bridge, and another single stage translation at the from-remote bridge. The to-remote translation takes the specific VA instance to PA translated address and the to-remote bridge translates this PA into the partition of the GAS allocated to the instance of the GAS at the remote processor. A specific address within different VA instances can therefore address a different location in the GAS. At the from-remote bridge, the identified instance of the GAS is then used to select the translation from the GAS to the PA of the remote process, and the from-remote translation tables within the processor then maps the address back into a specific VA.

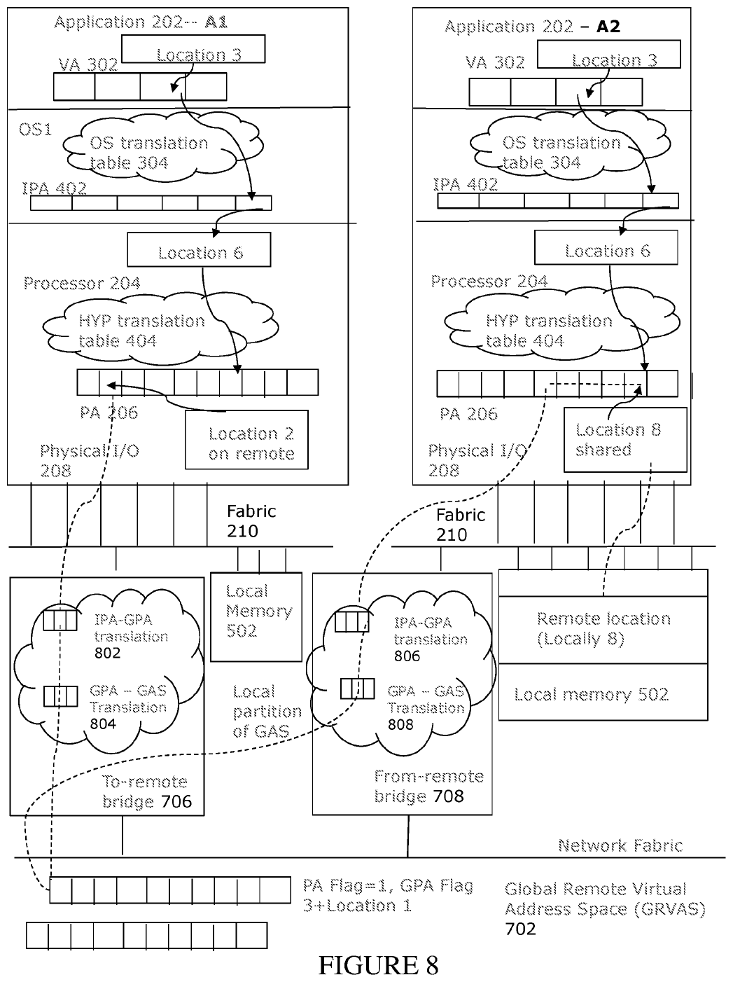

A to-remote and from-remote bridge with two stages of translation can also share partitions of the intermediate physical address table IPA between the multiple OS instances managed by the hypervisor instance of a processor, as is shown in FIG. 8, wherein IPA-GPA translation components 802, 806 provide the first stage of translation, and GPA-GAS translation components 804, 808 respectively provide the second stage of translation.

The present technology thus introduces a distributed memory translation hierarchy that aligns with each of the partitions of a translation within a processor, whereby a partition of a specific translation at one or more of the specific stages of processor memory address translation is exposed to the network fabric and memory requests to and from that partition are then mapped by a remote node into the corresponding instance of the local partition of the remote memory address at the corresponding hierarchy of the remote processor's translation.

In the present technology, there is thus provided a system by which the local address space of a processing system can use part of its local address space and access remote memory locations with other processing systems without each processing system requiring a mutually agreed or pre-defined partition of a global remote address space. Each node within a global system registers, either statically or dynamically, its ownership of a partition of the remote memory space. Accessing a remote memory location is achieved by identifying locally an address location within the local address space as is-remote and presenting it to a to-remote bridge which translates and augments this address into the remote address space.

The remote address space switch fabric is configured to present specific addresses to a from-remote bridge, configured locally at each node, to then translate the remote address into a location within that node's local address space. The local switch fabric provides the from-remote bridge direct memory access with coherent access to locations in the local address space.

The local address space can also include additional translations between the local address space and the address space used within a processing unit. For example, the IPA of a hypervisor or the virtual address space of an OS process may provide additional translations. The to- and from-bridges can include multiple stages or levels of translation to allow a remote address to be translated into the different address spaces defined by a processing unit. This is achieved by matching the translation hierarchy of the to- and from-remote bridge translation with the level in the hierarchy of the respective processing unit.

The translations at each level can be defined locally by software or hardware and do not have to match the translations defined within the corresponding processing unit.

There is thus provided by the present technology a method to indicate that an address (or a range of addresses) within a processor native address space, at any level of the processor address translation hierarchy, belongs to the remote address space. This is done by the Fabric or the Processor identifying an address as remote. This is provided implicitly by the address existing within a predefined partition of the local address space or by providing an attribute or flag stored along with the processor address translation table, at one or more levels of the processor translation hierarchy, to indicate that the translated address “is remote” and this attribute is made available by the processor on every memory transaction to route the memory transaction to the to-remote bridge.

There is further provided a method to translate a local address that has been identified as is-remote into a partition of the global remote address space. This is accomplished through a hierarchy of memory address translation tables within the to-remote bridge. The bridge may use one or more of the following inputs to define the translation: the local address that was identified as remote by the presence of the “is-remote” indication; the translation hierarchical level from the processor native translation that identified the address as remote; and the context identifier of the instance used in the processor translation table. The output remote address is then constructed directly, or through the use of a lookup table, using one or more of the inputs to form the address within the global remote address space.

In implementations, the present technology may make the system operable to translate a from-remote address formed through concatenating the address, an optional context-ID and an optional hierarchical translation-level, into a location in the local address space. This is accomplished through memory address translation tables with a hierarchical depth that matches the number of levels included in the GRVAS remote address. If a level attribute is included in the remote address, then this specify the level on which the rest of the address is presented for translation. If the ID is present, then this is used to define a context instance of the translation otherwise the address is translated directly. Software defines the specific mapping of each address. The remote address space will be partitioned into pages, or multiple ranges of addresses, with each partition defining the translation between the remote address and the local address.

The translation within each of the to- and from-remote bridges can be configured with a different mapping, enabling nodes to share a location of the memory that is stored at a different actual location in the global address space.

This means that different nodes can expose the same address for different locations in the global address space.

The translation within each of the to- and from-remote bridges can be configured with the same mapping, enabling nodes to share location of memory at the same offsets. This means that different nodes can expose the same address and same location in the local address spaces and use indirect references within a memory location to point to a common location.

Thus, in implementations, there may be provided a method by which multiple stages of fabric translation, within the to- and from-remote bridges, can be used to share different levels of processor address translation such that the memory manager set on each node can manage a disparity between the active configuration of each node process translation (each different process on each node with different translations on a global address space). It can decide between differences in translation from different nodes. This would enable two different applications running on two different nodes to have different views of the local memory (e.g. different global translations) but share locations of the global address space that overlap.

Given the sophistication of the present technology, here may also be provided a method to increase the size of a global address space by also exporting a translation context ID associated with the instance of a translation at a specific level of the process translation hierarchy. For example, to export multiple independent address spaces above a specific translation to a common address space, the translation table uses an ID to identify to which of the address spaces above the translation a specific mapping is assigned. (e.g. Use the processor translation instance ID to support sharing of an instance of the GAS as a specific level of fabric translation between multiple instances at a higher level of translation within the processor).

In an implementation of the present technology, there is provided a method by which a switch fabric that interconnects all nodes that share a global address space can register a partition of that address space as a set of locations that the fabric should present to that node's from-remote bridge. This can be implemented, for example, with a system in which every node is given a sequential numeric ID starting at 0, and in which the fabric contains an array of software defined address comparators holding the base address of a node's partition of the remote address space. The translation-level part of the remote address can be used either as part of the address to be translated, or can be used to define separate array of comparators so that nodes can own different ranges at different levels of translation. A context-ID, as described above, may be used either to index a second dimension of the comparators, or it may form part of the translated address. In one alternative, the switch fabric may use a computation to identify the from-remote bridge. In a further alternative, contemplated, but not essential, the switch may use some more complex data structure to map the location between the remote and local address spaces.

As will be appreciated by one skilled in the art, the present technique may be embodied as a system, method or computer program product. Accordingly, the present technique may take the form of an entirely hardware embodiment, an entirely software embodiment, or an embodiment combining software and hardware. The components described may thus comprise discrete hardware devices, core elements of devices, software or firmware entities, or hybrid hardware/software/firmware entities.

Furthermore, the present technique may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction-set to high-level compiled or interpreted language constructs.

It will also be clear to one of skill in the art that all or part of a logical method according to embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In one alternative, an embodiment of the present techniques may be realized in the form of a computer implemented method of deploying a service comprising steps of deploying computer program code operable to, when deployed into a computer infrastructure or network and executed thereon, cause the computer system or network to perform all the steps of the method.

In a further alternative, an embodiment of the present technique may be realized in the form of a data carrier having functional data thereon, the functional data comprising functional computer data structures to, when loaded into a computer system or network and operated upon thereby, enable the computer system to perform all the steps of the method.

It will be clear to one skilled in the art that many improvements and modifications can be made to the foregoing exemplary embodiments without departing from the scope of the present technique.

1. A machine-implemented method of operation of memory access and
control for an electronic data processing system, comprising:
allocating, at least one of statically and dynamically, ownership of a partition of a global remote memory address space in addition to local memory address space created by at least one local electronic data processing system;
presenting local memory access requests for global remote memory access through a to-remote bridge component identified within a partition of said local address space of said electronic data processing system for translation of said local address into a
corresponding translated address in a partition of said global remote memory address space; and
receiving a global remote memory access request within said allocated partition by said electronic data processing system
through a from-remote bridge for translation of said global remote address into a corresponding translated local address for direct and consistent access to said corresponding local memory address.

2. A machine-implemented method of operation of memory access and
control for an electronic data processing system, comprising:
allocating, at least one of statically and dynamically, ownership of a partition of a global remote memory address space in addition to local memory address space created by at least one local electronic
data processing system;
presenting local memory access requests for said global remote memory access through a to-remote bridge component identified by an “is-remote” flag associated with said entire local address of said electronic data processing system for translation of said local address into a corresponding translated address in a partition of said global remote memory address space; and
receiving a global remote memory access request within said
allocated partition by said electronic data processing system through a from-remote bridge for translation of said global remote address into a corresponding translated local address for direct and consistent access to said corresponding local memory address.

3. The method of operation of claim 1, wherein said corresponding translated local address for direct access to corresponding local memory address is coherent and consistent with concurrent access from any processor accessing said local memory address.

4. The method of operation of claim 1, further comprising at least one additional level of translation action within at least one of said to-remote bridge and said from-remote bridge when at least one of said local electronic data processing system and said remote electronic data processing system comprises a memory translation hierarchy in said associated processing units.

5. The method of operation of claim 4, wherein said memory translation hierarchy of processing units comprises at least one of a hypervisor-guest arrangement and an operating system-application arrangement, and wherein said guest and said application comprise at least one native memory arrangement subordinate to a hierarchically superior memory arrangement of said hypervisor and said operating system.

6. The method of operation of claim 4, further comprising:
storing at least one address at a level of said memory translation hierarchy of processing units with an additional indicator to indicate that said address translation is remote; and
making said additional indicator available on at least one memory transaction to cause routing of said memory transaction to said to-remote bridge component.

7. The method of operation of claim 4 whereby said local memory access request is presented with an associated processing unit translation hierarchical level and translation context identifier at said to-remote bridge.

8. The method of operation of claim 7, wherein said passing said local memory access request comprises using a translation context identifier associated with an instance of a translation at a level of said hierarchy of processing units within said bridge translation.

9. The method of operation of claim 7, wherein said passing said local memory access request and said translated memory address further comprises incorporating said translation context identifier and said level of hierarchy within said translated address.

10. The method of operation of claim 7, comprising:
responsive to receiving said from-remote translated address, parsing to detect presence of at least one of a translation context identifier
identifying an operating context within said from-remote translated address and a hierarchical level identifier within said from-remote translated address;
responsive to detecting a context identifier within said from-remote
translated address, selecting a corresponding local address associated with said operating context; and
responsive to detecting a hierarchical level identifier within said from-remote translated address, selecting a corresponding local address associated
with said hierarchical level.

11. The method of operation of claim 7, wherein said selecting responsive to detecting said hierarchical level identifier comprises further processing said hierarchical level identifier to derive a further hierarchical level identifier for use in said selecting a corresponding local address associated with a further hierarchical level.

12. The method of operation of claim 1, further comprising a plurality of translation stages within said to-remote and from-remote bridge components, said plurality of translation stages being operable to provide different address mappings to render each of a plurality of said electronic data processing systems operable to share an input one of a set of said memory addresses while each corresponding memory address in said partition of said global remote memory address space is stored at a different physical location.

13. The method of operation of claim 1 wherein a switch fabric that interconnects a plurality of instances of said electronic data processing system sharing a global address space is operable to be identified by a partition of an address space as a set of memory addresses to be presented at a from-remote bridge of at least one said electronic data processing system.

14. The method of operation of claim 1 wherein each device of a network of interconnected peer electronic data processing systems is operable to share control of said global remote memory address space by configuring at least one of a mapping of a to-remote address to said global remote memory address space and a mapping of a global remote memory address to a local address.

15. A computer program comprising computer program code to, when loaded into a computer system and executed thereon, cause said computer system to perform all the steps of the method of claim 1.

16. An electronic data processing system comprising a plurality of processors, a plurality of memories and a communications network, all co-operable to perform the steps of the method of claim 1.

17. An electronic data communication apparatus adapted by provision of at least one to-remote bridge component and at least one from-remote bridge component to perform the steps of the method of claim 1.

18. A memory apparatus adapted by provision of logic components operable to interact with a network of electronic data processing systems including at least one to-remote bridge component and at least one from-remote bridge component to perform the steps of the method of claim 1.

19. A machine-implemented method of associating an “is-remote” attribute with generation of a translated memory address, comprising:
providing a processing unit with a hierarchy comprising a plurality of levels of memory translation by which a memory address is translated into a resulting translated memory address;
at any level of memory translation within said hierarchy tagging at least one address with an “is-remote” attribute; and
subsequently maintaining a state of said “is-remote” attribute in association with said resulting translated memory address.

20. The machine-implemented method of claim 19, said tagged address comprising an is-remote indication and at least one additional attribute selected from:
a level of said translation hierarchy; and
a context identifier.
